(19) United States
(12) Patent Application Publication
(10) Pub. No.: US 2025/0375882 A1
(43) Pub. Date: Dec. 11, 2025

(54) ROBOT CONTROL DEVICE

(71) Applicant: FANUC CORPORATION, Yamanashi (JP)

(72) Inventors: Taketo ITAGAKI, Yamanashi (JP); Gou INABA, Yamanashi (JP); Takumi OYAMA, Yamanashi (JP)

(21) Appl. No.: 18/875,164

(22) PCT Filed: Jun. 28, 2022
(86) PCT No.: PCT/JP2022/025799

§ 371 Date: Dec. 16, 2024

(51) Int. Cl. B25J 9/16

(52) U.S. Cl. CPC B25J 9/1676

(57) ABSTRACT

Provided is a robot control device which controls a robot, the robot control device comprising: an area setting unit for setting an operation area in which the robot can operate or a restricted area that the robot cannot enter; a position calculation unit that calculates the position of the robot; an interference detection unit that detects the interference between the robot and the outer surface of the operation area, or the restricted area, on the basis of the calculated position of the robot; an operation state detection unit that detects the operation state of the robot from when the interference is detected; and a stop unit that stops the robot through stop control according to the detected operation state.

### RELATED APPLICATIONS

The present application is National Phase of International Application Number PCT/JP2022/025799, filed Jun. 28, 2022.

### FIELD

The present invention relates to a robot controller.

### BACKGROUND

Various technologies for ensuring human safety in a workspace where a robot system is arranged have been proposed. For example, PTL 1 describes as follows: “An arm robot performs low speed control of the speed of an arm when a person approaches a first-stage range and stops the arm when the person approaches a second-stage range closer to the robot than the first-stage range.” (Paragraph 0016).

PTL 2 describes as follows: “A robot system includes: a robot arm 2; a human body identifier 4 outputting human body identification information for distinguishing a human body from an object other than a human body in a predetermined monitoring area including a motion range of the robot arm 2; and a controller 3 controlling a motion of the robot arm 2, wherein, when detecting entry of a human body into the predetermined monitoring area by distinguishing a human body from an object other than a human body in the predetermined monitoring area, based on human body identification information output by the human body identifier 4, the controller 3 controls the robot arm 2 in such a way as to decelerate or stop a motion of the robot arm 2.” (ABSTRACT).

### CITATION LIST

### Patent Literature

[PTL 1] Japanese Unexamined Patent Publication (Kokai) No. 2000-202790 A
[PTL 2] Japanese Unexamined Patent Publication (Kokai) No. 2019-42871 A

### SUMMARY

### Technical Problem

For ensuring safety of a person in a workspace where a robot system is arranged, the robot system may be configured to set a motion zone in which a robot is allowed to move or a limiting zone where the robot is not allowed to enter as a calculative specified zone inside a controller and cause the robot to make an emergency stop when interference between the robot and the outer surface of the motion zone or the limiting zone is detected. While such a safety function is important in terms of ensuring safety of a person in a workspace, another aspect of the safety function is that an emergency stop imposes a considerable burden on the robot mechanism. It is desired to adaptively change stop control applied when interference between the robot and the outer surface of the motion zone or the limiting zone is detected.

### Solution to Problem

An aspect of the present disclosure is a robot controller for controlling a robot, the robot controller including: a zone setting unit configured to set a motion zone where the robot is allowed to move or a limiting zone where the robot is not allowed to enter; a position calculation unit configured to calculate a position of the robot; an interference detection unit configured to detect interference between the robot and an outer surface of the motion zone or the limiting zone, based on the calculated position of the robot; an operating state detection unit configured to detect an operating state of the robot when the interference is detected; and a stop unit configured to stop the robot according to stop control based on the detected operating state.

### Advantageous Effects of Invention

The aforementioned configuration enables suitable stop control to be applied based on the operating state of a robot when interference between the robot and the outer surface of a motion zone or a limiting zone is detected, and consequently provides stop control which can reduce a burden imposed on the robot mechanism while ensuring safety of an operator.

The objects, the features, and the advantages of the present invention, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating a configuration of a robot system according to an embodiment.

FIG. 2 is a diagram illustrating an example of setting a motion zone around a robot.

FIG. 3 is a diagram illustrating hardware configuration examples of a robot controller and an external input device.

FIG. 4 is a functional block diagram of a robot controller according to a first embodiment.

FIG. 5A is a diagram illustrating an operation example of stop control when a motion zone is specified in the first embodiment.

FIG. 5B is a diagram illustrating an operation example of the stop control when a motion zone is specified in the first embodiment.

FIG. 6A is a diagram illustrating an operation example of stop control when a limiting zone is specified in the first embodiment.

FIG. 6B is a diagram illustrating an operation example of the stop control when a limiting zone is specified in the first embodiment.

FIG. 7A is a diagram illustrating an operation example when a user coordinate system is set as reference coordinates in detection of a moving direction.

FIG. 7B is a diagram illustrating an operation example when the user coordinate system is set as the reference coordinates in detection of a moving direction.

FIG. 8 is a diagram illustrating a first example of a user interface screen for setting a specified zone and a stop method in the first embodiment.

FIG. 9 is a diagram illustrating a second example of a user interface screen for setting a specified zone and a stop method in the first embodiment.

FIG. 10 is a diagram for illustrating an operation example when a component of the moving direction of the robot is determined.

FIG. 11 is a diagram for illustrating a decision on a stop method when a plurality of components exist with respect to the moving direction of the robot.

FIG. 12 is a diagram illustrating interference between a robot model set to the robot and the outer surface of a motion zone.

FIG. 13 is a functional block diagram of a robot controller according to a second embodiment.

FIG. 14 is a diagram illustrating an example of assignment of an identification number to a motion zone.

FIG. 15 is a diagram illustrating an example of assignment of an identification number to a motion zone.

FIG. 16A is a diagram illustrating an operation example of stop control when interference between the outer surface of a motion zone and a robot occurs in the second embodiment.

FIG. 16B is a diagram illustrating an operation example of the stop control when interference between the outer surface of the motion zone and the robot occurs in the second embodiment.

FIG. 17A is a diagram illustrating an operation example of the stop control when interference between the outer surface of a limiting zone and the robot occurs in the second embodiment.

FIG. 17B is a diagram illustrating an operation example of the stop control when interference between the outer surface of the limiting zone and the robot occurs in the second embodiment.

FIG. 18 is a diagram illustrating a user interface screen for setting a specified zone and a stop method in the second embodiment.

FIG. 19 is a functional block diagram of a robot controller according to a third embodiment.

FIG. 20A is a diagram for illustrating stop control in a zone-disabled state.

FIG. 20B is a diagram for illustrating the stop control in a zone-enabled state.

FIG. 20C is a diagram for illustrating the stop control in the zone-enabled state.

FIG. 21 is a diagram illustrating a user interface screen for setting a specified zone and a stop method in the third embodiment.

### DESCRIPTION OF EMBODIMENTS

Next, embodiments of the present disclosure will be described with reference to drawings. In the referenced drawings, similar components or functional parts are given similar reference signs. For ease of understanding, the drawings use different scales as appropriate. Further, configurations illustrated in the drawings are examples for implementing the present invention, and the present invention is not limited to the illustrated configurations.

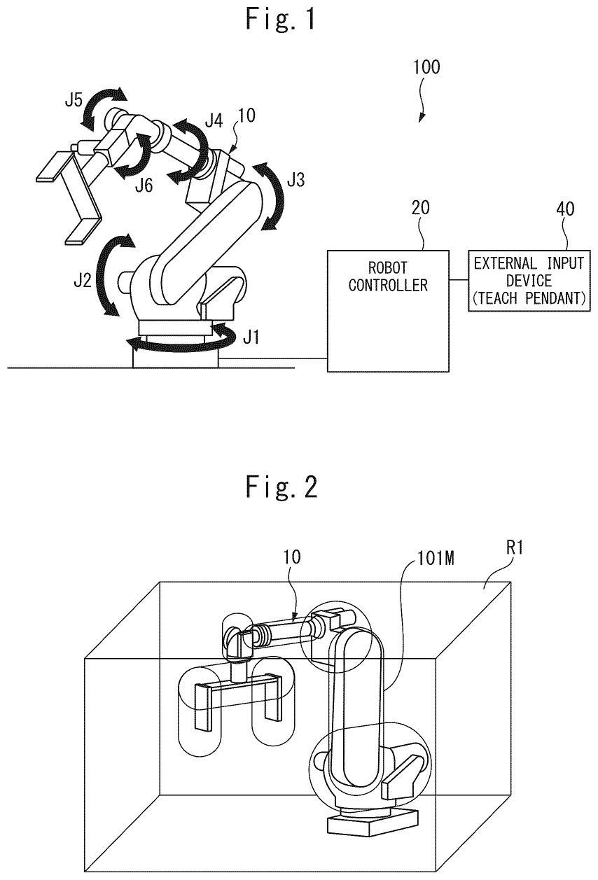

FIG. 1 is a diagram illustrating a configuration of a robot system according to an embodiment. As illustrated in FIG. 1, the robot system 100 includes a robot 10, a robot controller 20 controlling the robot 10, and an external input device 40 connected to the robot controller 20. For example, the external input device 40 is a teach pendant. An information processing device such as a tablet device, a smartphone, or a personal computer (PC) may be used as the external input device 40. It is assumed as an example that the robot 10 is a six-axis articulated robot. Various types of robots such as a parallel link robot and a dual-arm robot may be used as the robot 10 depending on a work target. Joint axes of the robot 10 are referred to as a J1 axis, a J2 axis, a J3 axis, a J4 axis, a J5 axis, and a J6 axis in this order from the base side. The J1 axis to the J6 axis correspond to rotation axes of actuators provided for the respective axes. FIG. 1 indicates directions of rotation of the axes by arrows J1 to J6.

The robot 10 can execute desired work with an end effector attached to the wrist. The end effector is an external device exchangeable according to the purpose and is, for example, a hand, a welding gun, or a tool. FIG. 1 illustrates an example in which a hand is used as an end effector.

The robot controller 20 has a safety function of stopping the robot 10 when the robot 10 departs from a motion zone or enters a limiting zone. The motion zone may be defined as a calculative (i.e., virtual) zone specifying a zone where the robot is allowed to move. The limiting zone may be defined as a calculative (i.e., virtual) zone specifying a zone where the robot is now allowed to enter. The safety function includes a function of stopping the robot when the robot departs from the motion zone (i.e., when the robot interferes with the outer surface (interface) of the motion zone) and a function of stopping the robot when the robot 10 interferes with the limiting zone.

The safety function will be described with reference to FIG. 2. FIG. 2 illustrates, as an example, a state where a motion zone R1 is set around the robot 10. In the case where the motion zone R1 is set, the robot 10 is stopped when interference between the robot 10 and the outer surface of the motion zone R1 is detected. When an interference check is performed by the safety function, a cylindrical or spherical model (a robot model 101M) may be set around the robot 10 in such a way as to enclose an arm, a joint, and a tool part, and the robot 10 may be stopped when interference between the robot model 101M and the outer surface of the motion zone R1 is detected. Also, in the case where a limiting zone is set, the robot may be stopped when interference between the limiting zone and the robot 10 or the robot model 101M is detected.

The robot controller 20 according to the present embodiment can stop the robot 10 according to stop control based on the operating state of the robot 10 when interference between the robot (or the robot model) and the outer surface of a motion zone or a limiting zone is detected. Consequently, the robot controller 20 can suppress occurrence of a situation in which a considerable burden is imposed on the mechanism of the robot 10 due to an emergency stop while maintaining human safety.

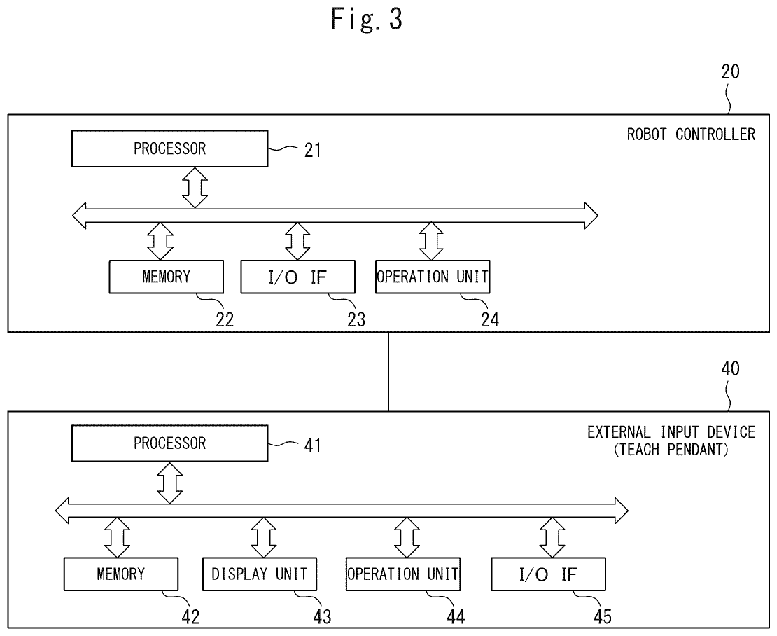

FIG. 3 illustrates hardware configuration examples of the robot controller 20 and the external input device 40. The robot controller 20 may have a configuration as a common computer including a memory 22 (such as a ROM, a RAM, or a nonvolatile memory), various input-output interfaces 23, an operation unit 24 including various operation switches, etc. that are connected to a processor 21 through a bus. The input-output interfaces 23 include a network interface, a serial interface, a sensor signal interface, and other external device interfaces.

The external input device 40 may have a configuration as a common computer including a memory 42 (such as a ROM, a RAM, or a nonvolatile memory), a display unit 43, an operation unit 44 including an input device such as a keyboard (or a software keyboard), various input-output interfaces 45, etc. that are connected to a processor 41 through a bus. The input-output interfaces 45 include a network interface, a serial interface, and other device equipment interfaces.

Three embodiments (a first embodiment to a third embodiment) related to the robot controller 20 will be described below. For convenience of explanation, a robot controller according to the first embodiment is referred to as a robot controller 20, a robot controller according to the second embodiment is referred to as a robot controller 20A, and a robot controller according to the third embodiment is referred to as a robot controller 20B.

### First Embodiment

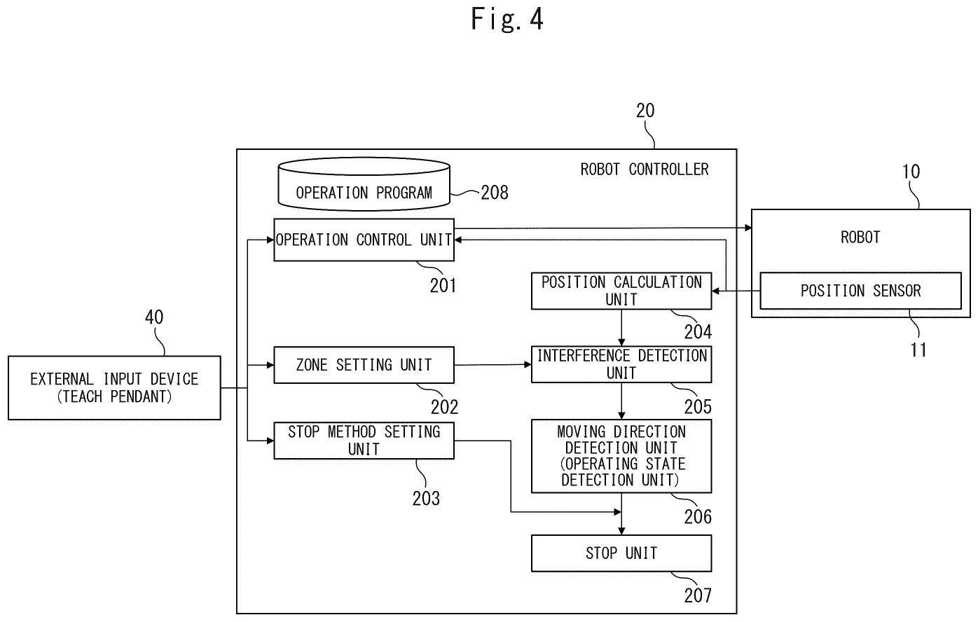

FIG. 4 is a functional block diagram of the robot controller 20 according to the first embodiment. As illustrated in FIG. 4, the robot controller 20 includes an operation control unit 201, a zone setting unit 202, a stop method setting unit 203, a position calculation unit 204, an interference detection unit 205, a moving direction detection unit 206, and a stop unit 207.

The operation control unit 201 controls the operation of the robot 10 in accordance with a command from an operation program 208 or an external input device (a teach pendant) 40. In other words, the operation control unit 201 moves a predetermined control part of the robot 10 in accordance with a command from the operation program 208 or the external input device 40 by executing servo control of a servomotor driving each joint axis of the robot 10, based on the command and feedback information from a position sensor (such as an encoder) 11 arranged at each axis of the robot 10.

The zone setting unit 202 provides a function of setting a specified zone (a motion zone or a limiting zone). The function provided by the zone setting unit 202 may include a function of accepting an input for setting a specified zone from an external device or a user and storing the input in a storage unit. For example, the zone setting unit 202 may be configured to accept an input for setting a motion zone or a limiting zone through a UI screen for performing setting of a motion zone or a limiting zone. In this case, the zone setting unit 202 may be configured to display the UI screen on a display screen of the display unit 43 of the external input device 40 and accept an input to the UI screen through an operation on an operation unit 44. The setting input in this case may include information about the three-dimensional position and the size of the specified zone. The zone setting unit 202 provides information about the specified zone to the interference detection unit 205.

The stop method setting unit 203 provides a function for performing setting related to stopping the robot when the robot 10 departs from the motion zone or interferes with the limiting zone. The function provided by the stop method setting unit 203 may include a function of accepting an input for setting a stop method from an external device or a user and storing the input in a storage unit. For example, the setting input in this case includes the following items.
(1) A reference coordinate system based on which the position and the moving direction of the robot are detected.
(2) Information in which a moving direction of the robot at the time of interference detection is associated with a type of stop control.

The type of stop control is hereinafter referred to as a stop category. A stop category represents a type of stop control under which a robot is stopped, and for example, may include the following.
(1) Stop category 0: Immediately stop the motion of the robot by turning off the power to servo control of the robot. Since the servo power is turned off while the robot is in motion in the stop category 0, a trajectory in decelerating motion of the robot is not controlled.
(2) Stop category 1: The servo power to the robot is turned off after the motion of the robot is decelerated and stopped.

The stop category 0 is used in a situation with a high degree of urgency. The robot stops faster in the stop category 0 than in the stop category 1 but the burden imposed on the robot mechanism is greater in the stop category 0 than in the stop category 1. The stop method setting unit 203 may have a function of accepting an input for setting a stop method through a UI screen. In this case, the stop method setting unit 203 may be configured to display the UI screen on the display screen of the display unit 43 of the external input device 40 and accept an input to the UI screen through an operation on the operation unit 44.

The position calculation unit 204 calculates the position of the robot 10 by kinematical calculations, based on position information from the position sensor 11 at each axis of the robot 10. “The position of the robot” as a target of position calculation may include the position of any part on the robot such as the position of a specific arm or joint on the robot in addition to the position of a control part such as a tool center point (TCP). When the robot 10 is provided with a tool (an end effector), a position on the tool may be considered a target of position calculation as “the position of the robot.” Calculation of a position may include calculation of a posture. The position calculation unit 204 provides the calculated position of the robot 10 to the interference detection unit 205.

The interference detection unit 205 detects whether the robot 10 interferes with the outer surface of the motion zone or the limiting zone, based on the position of the robot 10 provided by the position calculation unit 204 and position information of the motion zone or the limiting zone set in the zone setting unit 202.

The moving direction detection unit 206 functions as an operating state detection unit detecting the operating state of the robot 10 when interference is detected by the interference detection unit 205. The moving direction detection unit 206 detects the moving direction of the robot 10 when interference is detected by the interference detection unit 205. The moving direction of the robot can be determined based on position information of the robot 10 calculated by the position calculation unit 204 on a predetermined cycle. A coordinate system based on which the moving direction of the robot 10 is determined is acquired from the zone setting unit 202 or the stop method setting unit 203.

Based on setting information set through the stop method setting unit 203, the stop unit 207 stops the robot in accordance with a stop category corresponding to the moving direction of the robot 10 when interference between the robot 10 and the outer surface of the motion zone or the limiting zone is detected.

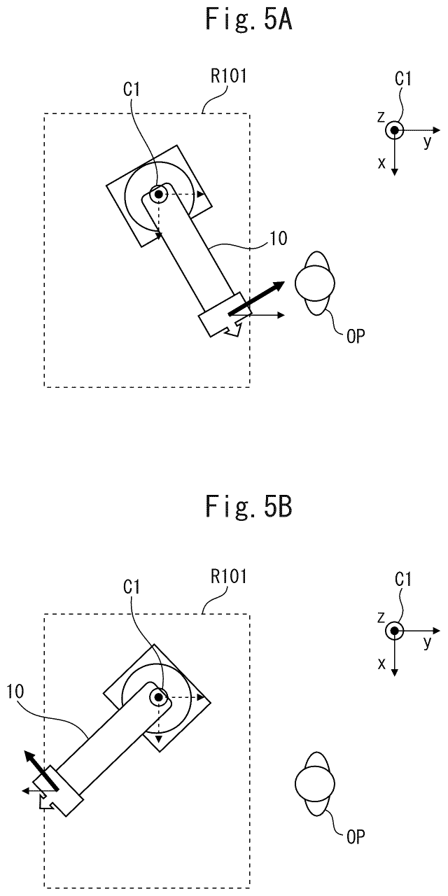

A specific operation example of the stop control when a motion zone is set as a specified zone will be described with reference to FIG. 5A and FIG. 5B. In a situation illustrated in FIG. 5A and FIG. 5B, a motion zone R101 is set to the robot 10, and an operator OP is at a position on the right side of the robot 10 when viewed from the front in the diagram. In the case where the robot 10 departs from the motion zone R101 in this situation, the robot controller stops the robot 10 according to the stop category 0, putting more emphasis on human safety, when the robot 10 is moving in a direction of approaching the operator OP while the robot controller stops the robot according to the stop category 1 in consideration of a burden imposed on the robot 10 in the remaining cases. It is assumed in this example that a world coordinate system C1 fixed to the base of the robot 10 is used as a reference coordinate system used for detection of the moving direction. In FIG. 5A (and similarly in other similar diagrams), the direction of each coordinate axis in the world coordinate system C1 is indicated in the upper-right part in the diagram for convenience of explanation. In this example, setting is performed in such a way that the stop category 0 is used when the moving direction of the robot 10 is a +Y-direction, and the stop category 1 is used for the remaining directions.

FIG. 5A illustrates a state when the robot 10 interferes with the outer surface of the motion zone R101. In this case, the moving direction of the robot 10 when the robot 10 interferes with the outer surface of the motion zone R101 is determined to be the +Y-direction, and the robot 10 is stopped according to the stop category 0. In this case, since the robot 10 departs from the motion zone R101 in a state of moving in a direction of approaching the operator OP, the robot controller causes the robot 10 to make an emergency stop according to the stop category 0 so that safety of the operator OP can be reliably ensured.

In the case of FIG. 5B, the moving direction of the robot 10 when the robot 10 interferes with the outer surface of the motion zone R101 is determined to be a-Y-direction, and the robot 10 is stopped according to the stop category 1. From the positional relation between the robot 10 and the operator OP shown in FIG. 5B, it is understood that safety of the operator OP is ensured when the robot 10 departs from the motion zone R101 by moving in the −Y-direction. Accordingly, in this case, by stopping the robot 10 according to the stop category 1, a burden imposed on the robot 10 can be reduced while ensuring safety of the operator OP.

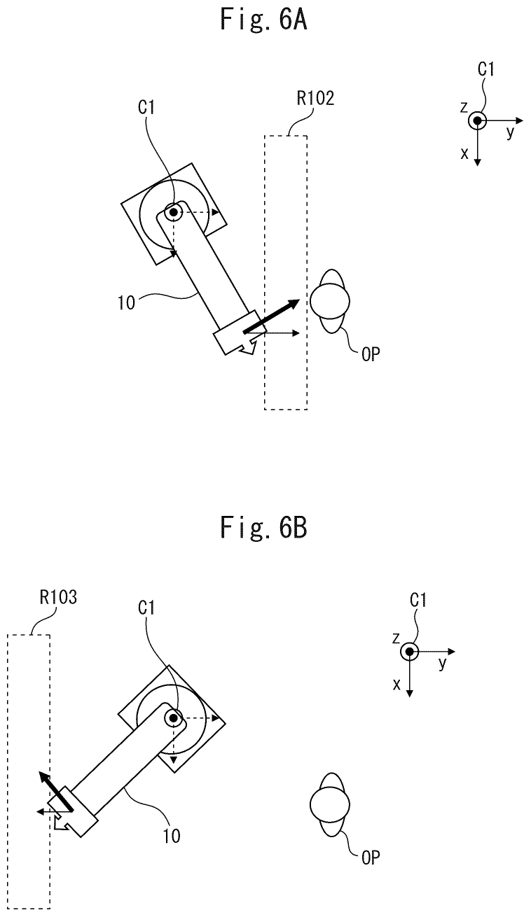

A specific operation example of the stop control when a limiting zone is set as a specified zone will be described with reference to FIG. 6A and FIG. 6B. In a situation illustrated in FIG. 6A and FIG. 6B, limiting zones R102 and R103 are set to the robot 10, and an operator OP is at a position on the right side of the robot 10 when viewed from the front in the diagram. The limiting zone R102 in FIG. 6A and the limiting zone R103 in FIG. 6B are arranged at different positions.

In the case where the robot 10 enters the limiting zone in this situation, the robot controller stops the robot 10 according to the stop category 0, putting more emphasis on urgency, when the robot 10 is moving in a direction of approaching the operator OP while the robot controller stops the robot according to the stop category 1 in consideration of a burden imposed on the robot 10 in the remaining cases. It is assumed in this example that the world coordinate system C1 fixed to the base of the robot 10 is used as a reference coordinate system used in detection of the moving direction. In this example, setting is performed in such a way that the stop category 0 is used when the moving direction of the robot 10 is the +Y-direction and the stop category 1 is used for the remaining directions.

FIG. 6A illustrates a situation in which the robot 10 enters the limiting zone R102 and interference is detected. In this case, the robot 10 moves in the +Y-direction, and therefore, the stop control according to the stop category 0 is performed. In this case, the robot 10 is moving in a direction of approaching the operator OP, and therefore, safety of the operator can be reliably ensured by causing the robot 10 to make an emergency stop according to the stop category 0.

In the situation in FIG. 6B, since the robot 10 is moving in the −Y-direction when the robot 10 interferes with the limiting zone R103, the robot 10 is stopped according to the stop category 1. From the positional relation between the robot 10 and the operator OP shown in FIG. 6B, it is understood that safety of the operator OP is ensured when the robot 10 enters the limiting zone R103 by moving in the −Y-direction. Accordingly, in this case, by stopping the robot according to the stop category 1, a burden imposed on the robot can be reduced while ensuring safety of the operator OP.

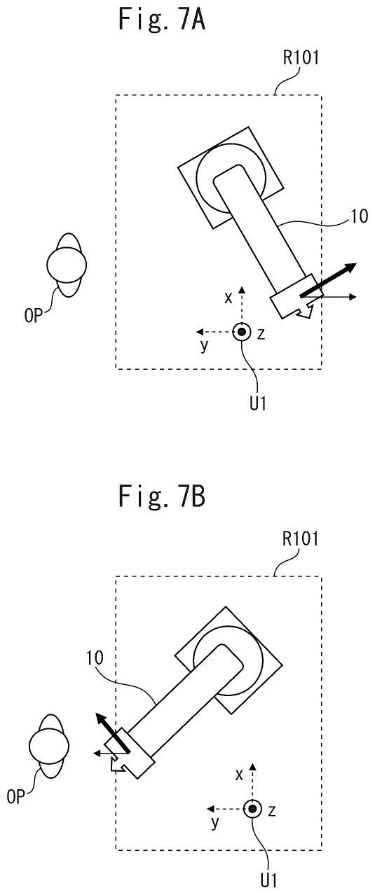

Any user coordinate system set by a user may also be used as a reference coordinate system used as a reference in detection of the moving direction in addition to the world coordinate system as is the case in the example described above. An operation example when a coordinate system set by a user (hereinafter referred to as a user coordinate system) is used as a reference coordinate system used in detection of the moving direction will be described with reference to FIG. 7A and FIG. 7B. For example, a user coordinate system is a coordinate system set to a workpiece in a motion zone or a workbench on which a workpiece is placed. FIG. 7A and FIG. 7B illustrate an operation example when a motion zone R101 is set as a specified zone. In this situation, an operator OP is at a position on the left side of the robot 10 when viewed from the front in the diagram. In the case where the robot 10 departs from the motion zone in this situation, the robot controller stops the robot 10 according to the stop category 0, putting more emphasis on urgency, when the robot 10 is moving in a direction of approaching the operator OP while the robot controller stops the robot according to the stop category 1 in consideration of a burden imposed on the robot 10 in the remaining cases. In this example, setting is performed in such a way that the stop category 0 is used when the moving direction of the robot 10 is the +Y-direction in a user coordinate system U1, and the stop category 1 is used for the remaining direction.

FIG. 7A illustrates a state when the robot 10 interferes with the outer surface of the motion zone R101. In the case of FIG. 7A, the moving direction of the robot 10 when the robot 10 interferes with the outer surface of the motion zone R101 is determined to be a-Y-direction, and the robot 10 is stopped according to the stop category 1. From the positional relation between the robot 10 and the operator OP shown in FIG. 7A, it is understood that safety of the operator OP is ensured when the robot 10 departs from the motion zone R101 by moving in the −Y-direction. Accordingly, in this case, by stopping the robot according to the stop category 1, a burden imposed on the robot can be reduced while ensuring safety of the operator.

FIG. 7B illustrates a state when the robot 10 interferes with the outer surface of the motion zone R101. In this case, the moving direction of the robot 10 when the robot 10 interferes with the outer surface of the motion zone R101 is determined to be the +Y-direction, and the robot 10 is stopped according to the stop category 0. In this case, the robot 10 departs from the motion zone R101 by moving in a direction of approaching the operator OP, and therefore, safety of the operator can be reliably ensured by causing the robot 10 to make an emergency stop according to the stop category 0.

Since a user coordinate system is a coordinate system easily and intuitively recognized by a user, by allowing a user to set a user coordinate system as a reference coordinate system in the safety function, it is possible for a user to easily and intuitively set a stop method and recognize the moving direction of the robot.

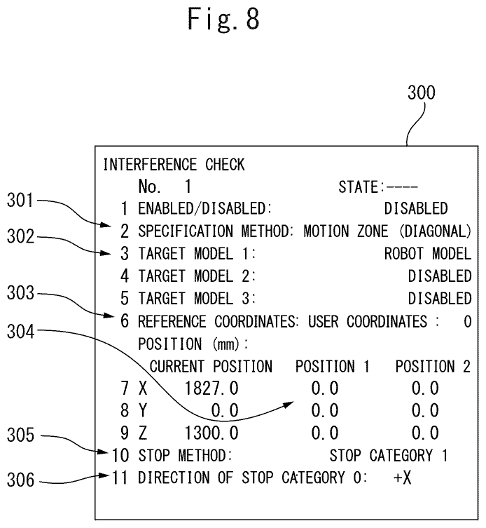

FIG. 8 is a diagram illustrating a first example of a user interface (UI) screen for setting a specified zone and a stop method. A UI screen 300 is provided by the function of the zone setting unit 202 and the stop method setting unit 203. The UI screen 300 may be displayed on the display screen of the display unit 43 of the external input device 40, and an input to the UI screen may be accepted through an operation on the operation unit 44.

The UI screen 300 includes a zone specification field 301 in which one of a motion zone and a limiting zone can be specified as a specified zone. FIG. 8 illustrates an example in which a motion zone is specified as a specified zone. For example, the position of the motion zone can be set in a position specification field 304. For example, when a rectangular parallelepipedic zone is set, diagonal positions are specified in the position specification field 304. A robot model for an interference check, as illustrated in FIG. 2, can be specified in a target model specification field 302.

The UI screen 310 further includes a specification field 305 for specifying a stop method, a specification field 306 for specifying the moving direction of the stop category 0, and a specification field 303 for specifying a reference coordinate system when the moving direction is detected. In this example, the stop category 0 is used only for the direction specified in the specification field 306 for specifying the direction of the stop category 0, and the stop category specified in the specification field 305 for a stop method is used for the remaining directions. In the setting in FIG. 8, the robot is stopped according to the stop category 0 only in the +X-direction and is stopped according to the stop category 1 in the remaining directions. Options that can be specified in the specification field 306 for a stop category may include “none,” “+X,” “+Y,” “+Z,” “−X,” “−Y,” and “−Z.”

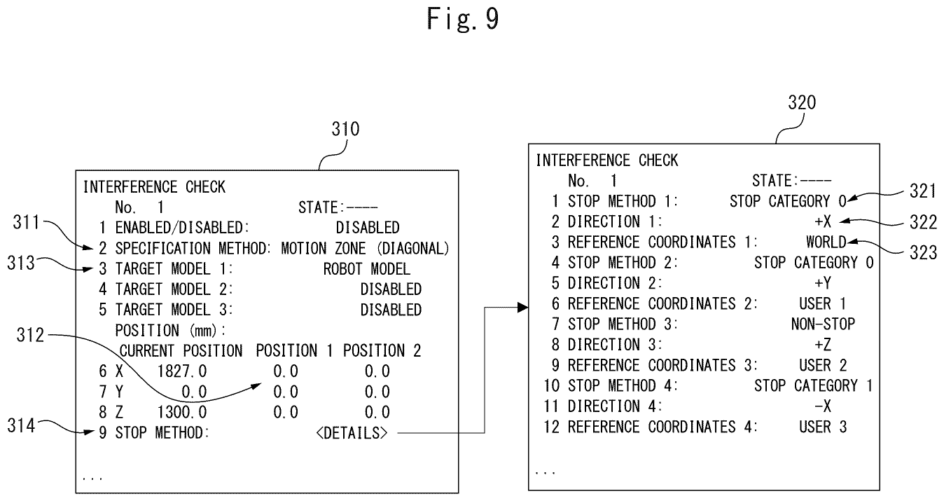

FIG. 9 is a diagram illustrating a second example of UI screens for setting a specified zone and a stop method. The UI screens are provided by the function of the zone setting unit 202 and the stop method setting unit 203. The UI screens may be displayed on the display screen of the display unit 43 in the external input device 40, and an input to the UI screen may be accepted through an operation on the operation unit 44. A UI screen 310 illustrated on the left side in FIG. 9 is mainly related to setting of a specified zone. A UI screen 320 illustrated on the right side in FIG. 9 is a setting screen related to detailed setting of a stop method.

The UI screen 310 includes a zone specification field 311 in which one of a motion zone and a limiting zone can be specified as a specified zone. FIG. 9 illustrates an example of a motion zone being specified as a specified zone. For example, the position of the motion zone can be set in a position specification field 312. For example, when a rectangular parallelepipedic zone is set, diagonal positions are specified in the position specification field 312. A robot model for an interference check, as illustrated in FIG. 2, can be specified in a target model specification field 313.

The UI screen 310 includes a stop method specification field 314. By performing an operation of selecting the stop method specification field 314, the UI screen 320 for performing detailed setting of a stop method can be opened. As illustrated in FIG. 9, the UI screen 320 is configured such that different stop methods can be set for the respective moving directions. The UI screen 320 allows setting of
(1) stop category (a specification field 321),
(2) the moving direction of the robot when interference occurs (a specification field 322), and
(3) a reference coordinate system used when the moving direction is detected (a specification field 323)
for each stop method.

Four stop methods with the following contents are set in the UI screen 320 in FIG. 9.
(1) Stop method 1: stop category 0, moving direction: +X-direction, reference coordinate system: world coordinate system
(2) Stop method 2: stop category 0, moving direction: +Y-direction, reference coordinate system: user coordinate system 1
(3) Stop method 3: non-stop setting, moving direction: +Z-direction, reference coordinate system: user coordinate system 2
(4) Stop method 4: stop category 1, moving direction: −X-direction, reference coordinate system: user coordinate system 3

A component of the moving direction of the robot 10 when the robot 10 interferes with the outer surface of the motion zone or the limiting zone may be detected, and a stop category may be decided based on the detected component. When a plurality of components are detected as the moving direction, the robot controller 20 may decide on a stop category by the following procedures.
(A1) Detect interference between the robot and the outer surface of the motion zone or the limiting zone.
(A2) Detect a plurality of components of the moving direction.
(A3) Acquire a stop category set to each moving direction component detected in the procedure
(A2).
(A4) Employ a stop category with the highest priority out of the stop categories acquired in the procedure (A3).

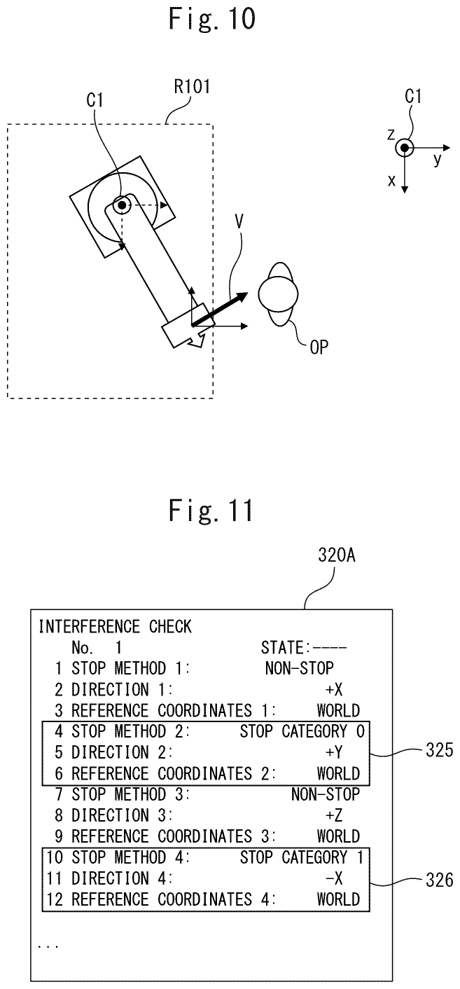

A specific decision on a stop category based on the aforementioned procedures will be described with reference to FIG. 10 and FIG. 11. FIG. 10 illustrates a situation in which two components are detected as the moving direction when the robot 10 departs from a motion zone R101. In the situation in FIG. 10, a +Y component and a-X component are acquired as components of the moving direction V of the robot. FIG. 11 illustrates a setting content of a stop method used in this example (a UI screen 320A).

The components of the moving direction acquired in this situation in FIG. 10 are the +Y component and the −X component, and therefore, stop categories acquired in the aforementioned procedure (A3) are the stop category 0 and the stop category 1 as described in fields with reference signs 325 and 326 in FIG. 11. As for priority of a stop category, a stop category having greater importance in terms of safety is assigned higher priority, as an example. In this case, the stop category 0 has higher priority than the stop category 1. Accordingly, in this case, the stop category 0 is employed in the procedure (A4), and the robot 10 is stopped according to the stop category 0. Consequently, when the robot 10 departs from the motion zone R101 by moving in a direction of approaching an operator OP as illustrated in FIG. 10, the robot 10 is caused to make an emergency stop according to the stop category 0 so as to ensure safety of the operator OP.

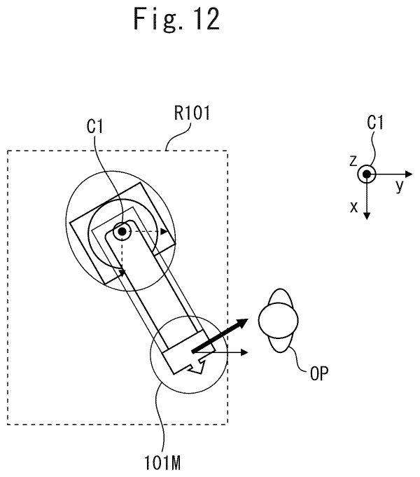

In order to detect interference between the robot 10 and the outer surface of the motion zone or the limiting zone by calculation, the robot controller may determine, by using the robot model 101M as illustrated in FIG. 12, whether interference between a robot model 101M covering the robot 10 (see FIG. 2) and the outer surface of the motion zone or the limiting zone occurs. FIG. 12 illustrates a situation in which a state of the robot model 101M set to the robot 10 interfering with the outer surface of the motion zone R101 (the robot model 101M deviating from the motion zone R101) is detected. Thus, a processing load on the calculation can be reduced by detecting the interference by using the robot model 101M.

### Second Embodiment

The robot controller 20A according to the second embodiment will be described below. The robot controller 20A according to the second embodiment is configured to detect, out of faces constituting the outer surface of a motion zone or a limiting zone, a face with which a robot 10 interferes and allow setting of a stop category based on the face on which interference has detected.

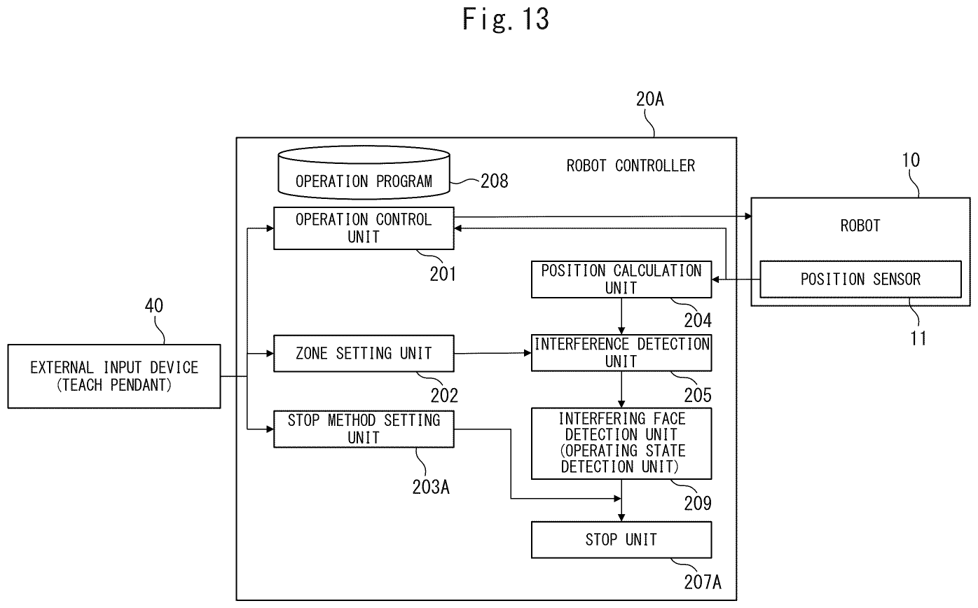

FIG. 13 is a functional block diagram of the robot controller 20A according to the second embodiment. In the functional block diagram in FIG. 13, a functional block being the same as a functional block in the robot controller 20 according to the first embodiment illustrated in FIG. 4 is given the same reference sign. As illustrated in FIG. 13, the robot controller 20A includes an operation control unit 201, a zone setting unit 202, a stop method setting unit 203A, a position calculation unit 204, an interference detection unit 205, an interfering face detection unit 209, and a stop unit 207A.

The stop method setting unit 203A can provide a function for setting a stop category for each face of the outer surface of a motion zone or a limiting zone. The interfering face detection unit 209 functions as an operating state detection unit detecting the operating state of the robot 10 when interference is detected by the interference detection unit 205. When interference between the robot 10 and the outer surface of the motion zone or the limiting zone is detected, the interfering face detection unit 209 determines which of faces forming the outer surface of the motion zone or the limiting zone the robot 10 interferes with.

The stop unit 207A stops the robot 10 according to a stop category set to a face detected by the interfering face detection unit 209.

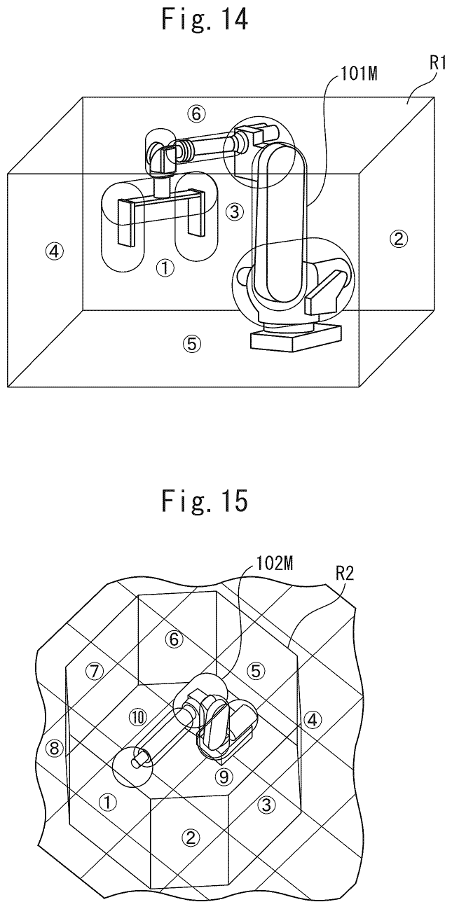

When a stop category is set for each face of a specified zone, identification information may be assigned to each face of the specified zone as illustrated in FIG. 14 and FIG. 15. FIG. 14 illustrates an example of, when a rectangular parallelepipedic motion zone R1 is set, assigning identification numbers 1 to 6 to the front, the right side, the back, the left side, the bottom face, and the top face, respectively. The identification numbers 1 to 6 are indicated by circled numbers in FIG. 14.

FIG. 15 illustrates a state of setting an octagonal prismatic motion zone R2 around the robot, assigning identification numbers 1 to 8 to eight sides, and assigning identification numbers 9 and 10 to the top face and the bottom face, respectively. The identification numbers 1 to 10 are indicated by circled numbers in FIG. 15. The interfering face detection unit 209 and the stop unit 207A can identify the faces of the outer surface of the specified zone through use of the identification numbers. Thus, by assigning identification information to each face of the outer surface constituting a specified zone so as to identify each face, a stop category for each face can be efficiently defined even when the specified zone is set as a polyhedron.

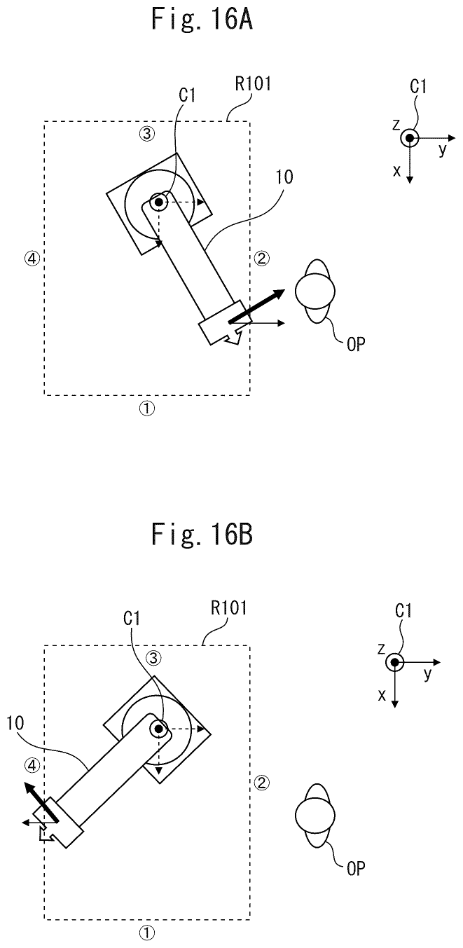

FIG. 16A illustrates a state in which a rectangular parallelepipedic motion zone R101 is set and when the lower side is assumed to be the front side in the diagram, identification numbers 1 to 4 are assigned to the front, the right side, the back, and the left side of the motion zone R101, respectively. The identification numbers are indicated by circled numbers in FIG. 16A (and similarly in other similar diagrams). It is assumed in this example that a stop category 0 is set to a face with the identification number 2 (the right side), and a stop category 1 is set to the remaining faces.

FIG. 16A illustrates a situation in which the robot 10 departs from the motion zone R101 in a state of interfering with a face with the identification number 2 (the right side). In this case, the robot 10 is stopped according to the stop category 0 assigned to the face with the identification number 2 (the right side). In this case, the robot 10 departs from the motion zone R101 by moving in a direction of approaching an operator OP, and therefore, safety of the operator OP is reliably ensured.

FIG. 16B illustrates a situation in which the robot 10 departs from the motion zone R101 in a state of interfering with a face with the identification number 4 (the left side). In this case, the robot 10 is stopped according to the stop category 1 assigned to the face with the identification number 4 (the left side). In this case, since the robot 10 departs from the motion zone R101 by moving in a direction of moving away from the operator OP, the robot controller operates to prevent a burden from being imposed on the robot 10 while ensuring safety of the operator OP.

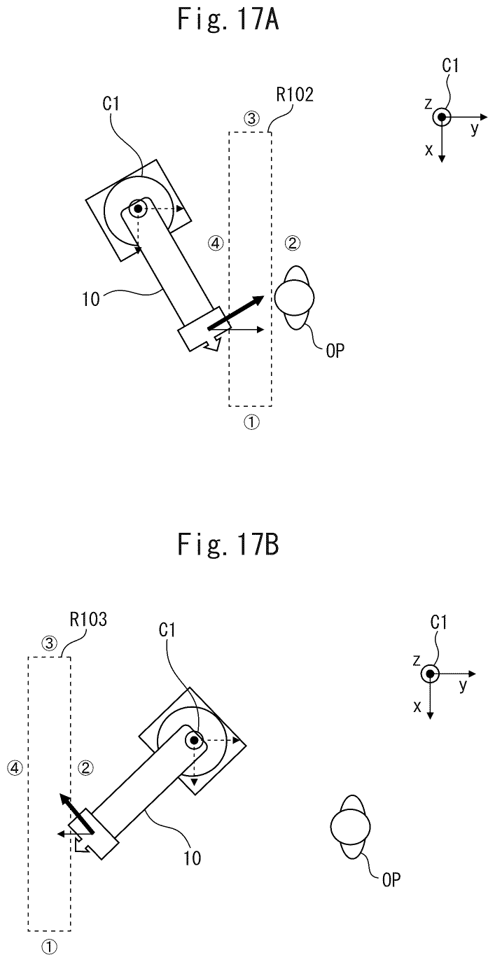

FIG. 17A and FIG. 17B illustrate an operation example when an identification number is assigned to each face forming the outer surface of a limiting zone. The figures illustrate a state in which identification numbers 1 to 4 are assigned to the front, the right side, the back, and the left side of each of the limiting zones R102 and R103, respectively, assuming the lower side to be the front side in the diagram. It is assumed in this case that the stop category 0 is set to a face with the identification number 4 (the left side), and the stop category 1 is set to the remaining faces.

FIG. 17A illustrates a situation in which the robot 10 enters the limiting zone R102 by interfering with the face of the limiting zone R102 with the identification number 4 (the left side). In this case, the robot 10 is stopped according to the stop category 0 set to the face with the identification number 4 (the left side). An operator OP is on the side of the right side of the limiting zone R102 in the situation in FIG. 17A. Accordingly, in a situation in which the robot 10 enters the limiting zone R102 in such a way as to approach the operator OP as illustrated in FIG. 17A, the robot 10 is stopped according to the stop category 0 so as to reliably ensure safety of the operator OP.

FIG. 17B illustrates a situation in which the robot 10 enters the limiting zone R103 by interfering with a face of the limiting zone R103 with the identification number 2 (the right side). In this case, the robot 10 is stopped according to the stop category 1 set to the face with the identification number 2 (the right side). The operator OP is on the side of the right side of the limiting zone R103 in the situation in FIG. 17B. Accordingly, in a situation in which the robot 10 enters the limiting zone R103 in such a way as to move away from the operator OP as illustrated in FIG. 17B, the robot 10 is stopped according to the stop category 1 so as to prevent a burden from being imposed on the robot 10 while ensuring safety of the operator OP.

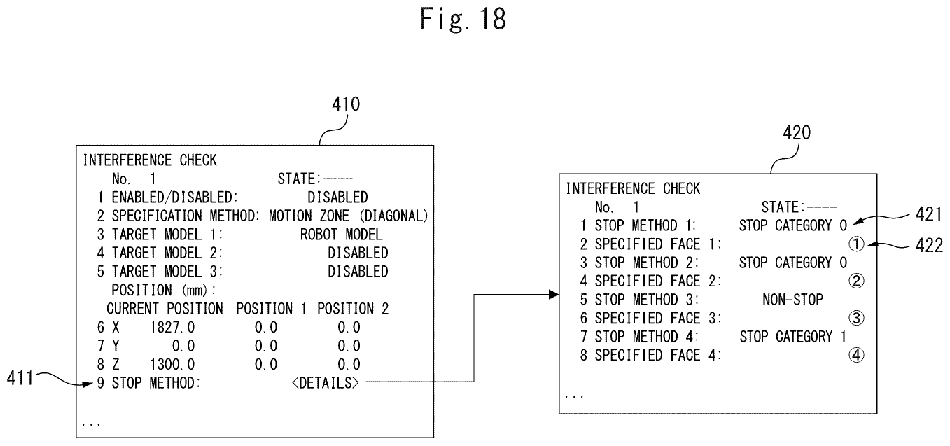

FIG. 18 is a diagram illustrating an example of user interface (UI) screens for setting a specified zone and a stop method, according to the second embodiment. The UI screens are provided by the function of the zone setting unit 202 and the stop method setting unit 203A. The UI screens may be displayed on a display screen of a display unit 43 in an external input device 40, and an input to the UI screen may be accepted through an operation on an operation unit 44. A UI screen 410 illustrated on the left side in FIG. 18 is mainly related to setting of a specified zone. A UI screen 420 illustrated on the right side in FIG. 18 is a setting screen related to detailed setting of a stop method.

The UI screen 410 includes specification fields similar to the specification fields 311 to 314 on the UI screen 310 illustrated in FIG. 9. The UI screen 410 includes a specification field 411 for a stop method. For example, by performing an operation of selecting the specification field 411, the UI screen 420 for setting details of a stop method can be opened. As illustrated in FIG. 18, the UI screen 420 is configured such that a plurality of stop methods can be set for the respective faces with which the robot interferes. On the UI screen 420,
(1) a stop category (a specification field 421) and
(2) a face with which the robot interferes (a specification field 422) can be set for each stop method.

By thus setting a stop method for each face, setting contents of the stop method can be simplified. An operator has only to perform setting of associating each face of a specified zone with a stop category and therefore can perform setting of a stop method in an easily and intuitively recognized manner.

Four stop methods are set on the UI screen 420 in FIG. 18 with the following contents.
Stop method 1: specified face 1 (identification number 1), stop category 0
Stop method 2: specified face 2 (identification number 2), stop category 0
Stop method 3: specified face 3 (identification number 3), non-stop
Stop method 4: specified face 4 (identification number 4), stop category 1

### Third Embodiment

The robot controller 20B according to the third embodiment will be described below. The robot controller 20B according to the third embodiment is configured to allow setting of whether a limiting zone is enabled or disabled, set a limiting zone to be enabled when an operator enters the limiting zone, and stop a robot 10 according to a stop category based on the moving direction of the robot in the limiting zone when the operator enters the limiting zone.

The aforementioned function of the robot controller 20B can be achieved by arranging a sensor for detecting entry of a person into a limiting zone, inputting a signal from the sensor to the robot controller 20B, and performing control of enabling the limiting zone when entry of a person into the limiting zone is detected. Various sensors such as a light curtain, a safety mat, and an area sensor can be used as the sensor for detecting entry of a person into the limiting zone. In addition to a signal from a sensor, an input from an I/O device such as a sequencer through the input-output interface 45 may also be used as a signal for detecting entry of a person into the limiting zone.

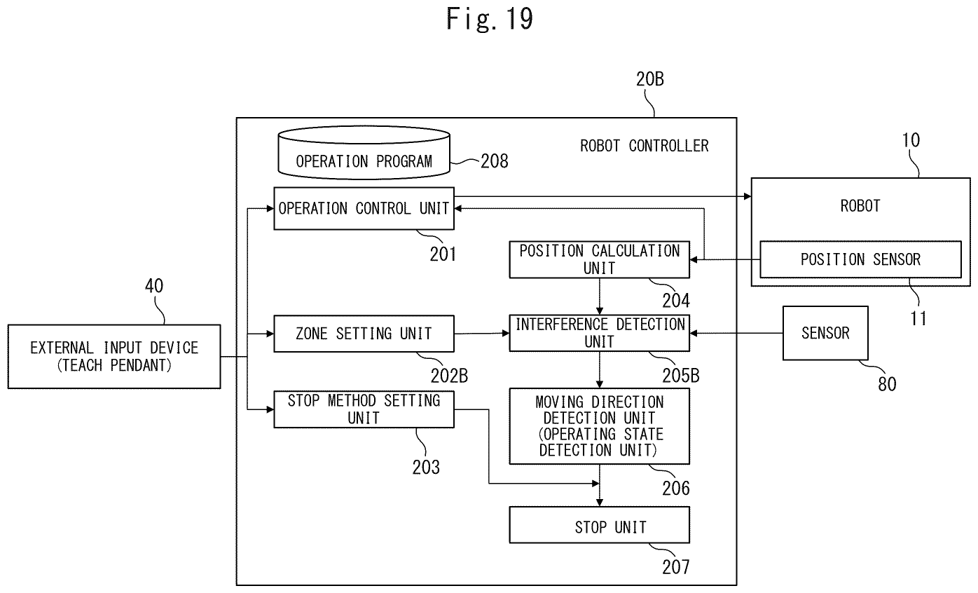

FIG. 19 is a functional block diagram of the robot controller 20B according to the third embodiment. In FIG. 19, a functional block being the same as a functional block in the robot controller 20 according to the first embodiment is assigned the same reference sign. As illustrated in FIG. 19, the robot controller 20B includes a zone setting unit 202B, a stop method setting unit 203, a position calculation unit 204, an interference detection unit 205B, a moving direction detection unit 206, and a stop unit 207 as functional blocks related to the safety function. A detection signal from a sensor 80 for detecting entry of a person into a limiting zone is input to the interference detection unit 205B.

In addition to the function as the zone setting unit 202 according to the first embodiment, the zone setting unit 202B is configured to provide a function for setting a specified zone to be enabled or disabled. When entry of a person into the limiting zone is detected by the sensor 80, the interference detection unit 205B enables the limiting zone and when interference between the robot 10 and the limiting zone is detected in this situation, notifies the moving direction detection unit 206 of the detection. On the other hand, when entry of a person into the limiting zone is not detected by the sensor 80, the interference detection unit 205B assumes the limiting zone to be disabled.

The moving direction detection unit 206 functions as an operating state detection unit detecting the operating state of the robot 10 when interference is detected by the interference detection unit 205B. The moving direction detection unit 206 detects the moving direction of the robot 10 when a person enters the limiting zone in a situation in which interference between the robot 10 and the limiting zone is detected. The stop unit 207 stops the robot 10 according to stop control based on the moving direction of the robot 10 when a person enters the limiting zone in a situation in which interference between the robot 10 and the limiting zone is detected.

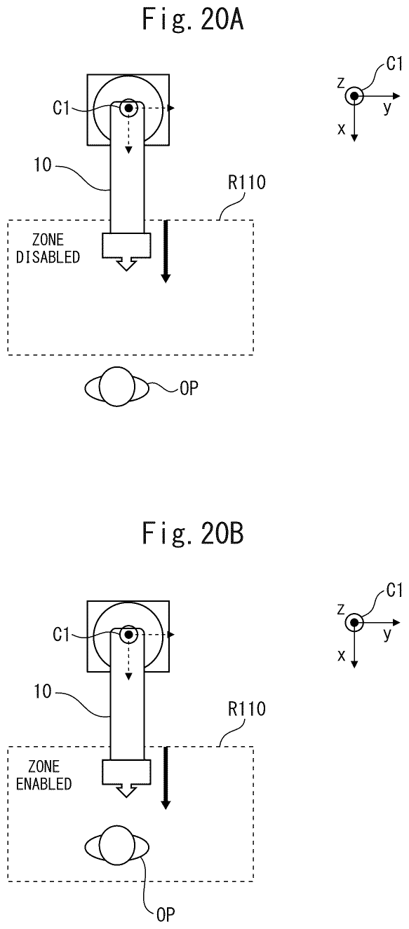

A specific operation example will be described with reference to FIG. 20A to FIG. 20C. FIG. 20A to FIG. 20C illustrate a situation in which a limiting zone R110 is set on the front side of the robot 10, and an operator OP may enter the limiting zone R110. It is assumed in this example that, with a world coordinate system C1 set at the base of the robot 10 as a reference, a stop category 0 is set to a +X-direction as a moving direction, and a stop category 1 is set to a −X-direction as a moving direction.

In a state of FIG. 20A, the operator OP has not entered the limiting zone R110, and therefore the limiting zone R110 is disabled. In this case, the interference detection unit 205B assumes the limiting zone R110 to be disabled and does not perform a detection check of interference between the robot 10 and the limiting zone R110. In this example, although stop control when the robot 10 interferes with the limiting zone R110 is not executed, it is possible to prevent a burden from being imposed on the robot 10 due to stop control while maintaining safety of the operator OP.

FIG. 20B illustrates a situation in which the operator OP has entered the limiting zone R110. In this case, entry of the operator OP into the limiting zone R110 is detected by the sensor 80, and the limiting zone R110 is enabled. In this situation, the robot 10 has entered the limiting zone R110 when the limiting zone R110 is enabled, and the moving direction of the robot 10 is the +X-direction; and therefore, the robot 10 is caused to make an emergency stop according to the stop category 0. Consequently, safety of the operator OP is reliably ensured.

FIG. 20C illustrates a situation in which the operator OP has entered the limiting zone R110. In this case, entry of the operator OP into the limiting zone R110 is detected by the sensor 80, and the limiting zone R110 is enabled. In this situation, the robot 10 has entered the limiting zone R110 when the limiting zone R110 is enabled, and the moving direction of the robot 10 is the −X-direction; and therefore, the robot 10 is stopped according to the stop category 1. In this case, since the robot 10 is moving in a direction of moving away from the operator OP, the burden imposed on the robot 10 is reduced in a state where safety of the operator OP is maintained.

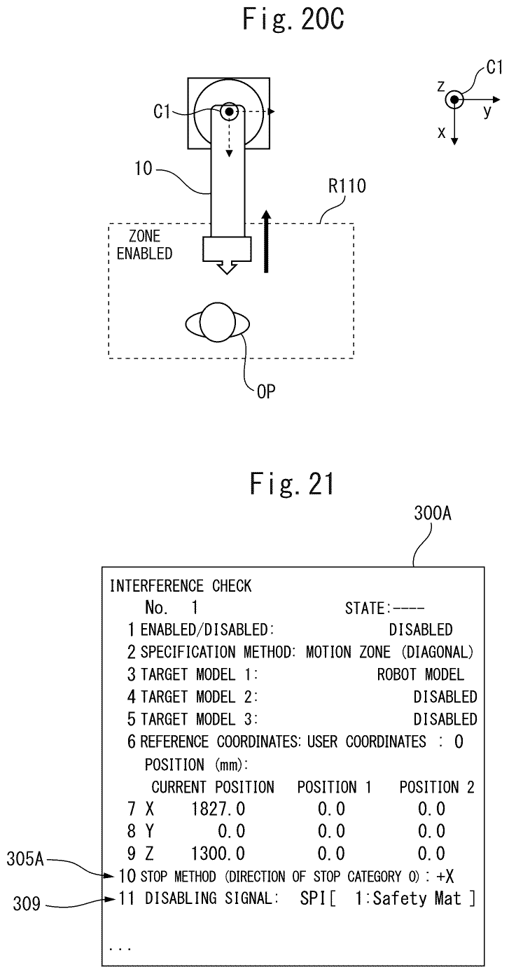

FIG. 21 illustrates an example of a UI screen used in setting according to the third embodiment. A UI screen 300A is provided by the function of the zone setting unit 202B and the stop method setting unit 203. The UI screen 300A may be displayed on a display screen of a display unit 43 of an external input device 40, and an input to the UI screen 300A may be accepted through an operation on an operation unit 44. The UI screen 300A used in the present embodiment may be provided in a form of adding a specification field 309 for specifying a signal for enabling/disabling a specified zone to the UI screen 300 according to the first embodiment described with reference to FIG. 8. As an example, in the UI screen 300A, a signal from a safety mat is set as a signal for disabling a limiting zone. Based on a setting content in a specification field 309, the interference detection unit 205B can identify what state of a signal from the sensor 80 represents an instruction for disabling the limiting zone. In the UI screen 300A, a direction of the stop category 0 can be specified in a specification field 305A for specifying a stop method.

While an operation example of setting a limiting zone as a specified zone and performing stop control while disabling or enabling the limiting zone based on a signal from the sensor 80, has been described in the present embodiment, a configuration in which a motion zone is set as a specified zone, entry of a person into the motion zone is detected by the sensor 80, and stop control is performed while disabling or enabling the motion zone based on a signal from the sensor 80, may be employed. Also, in this case, stop control which reduces the burden imposed on the robot while ensuring safety of an operator can be achieved similarly to the embodiment described above.

In the present embodiment, an operation example in which the robot controller allows setting of enabling or disabling the zone in the case where the robot is stopped in accordance with a stop category corresponding to the moving direction of the robot 10 when interference with the outer surface of a motion zone or a limiting zone is detected has been described. Also, in the second embodiment in which a face of the outer surface of a motion zone or a limiting zone interfering with the robot 10 is detected when interference between the robot 10 and the outer surface of the motion zone or the limiting zone is detected and the robot 10 is stopped according to a stop category set to the detected face, the robot controller may allow setting of enabling or disabling the zone so that stop control can be performed while disabling or enabling a motion zone based on a signal from the sensor 80. Also, in this case, stop control reducing a burden imposed on the robot while ensuring safety of an operator can be achieved similarly to the embodiment described above.

As described above, according to each embodiment, when interference between a robot and the outer surface of a motion zone or a limiting zone is detected, suitable stop control can be applied based on the operating state of the robot, and consequently, stop control which can reduce a burden imposed on the robot mechanism while ensuring safety of an operator can be achieved.

While the present invention has been described above by using the typical embodiments, it may be understood by a person skilled in the art that changes, and various other changes, omissions, and additions can be made to the aforementioned embodiments without departing from the scope of the present invention.

For example, the arrangement of functions illustrated in the functional block diagrams of the robot controllers according to the embodiments described above (FIG. 4, FIG. 13, and FIG. 19) are examples, and various modified examples related to the arrangement of the functional blocks may be configured. For example, there may be a configuration example of arranging at least part of the functional blocks being related to the safety function and being arranged in the robot controller (such as the zone setting unit and the stop method setting unit) in a teach pendant as the external input device. In this case, an overall function in which the function of the teach pendant as the external input device is combined with the function of the robot controller may be defined as a robot controller.

It goes without saying that, in regard to detection of interference between a robot and the outer surface of a motion zone or a limiting zone, “interference between the robot and the outer surface of the motion zone or the limiting zone is detected” means interference between any part (may include any part from the base of the robot to a tool part) constituting the robot (or a robot model covering the robot) and the outer surface of the motion zone or the limiting zone is detected. Further, it goes without saying that, in regard to detection of a moving direction or a detection of an interfering face when interference between a robot and the outer surface of a motion zone or a limiting zone is detected, “the moving direction of the robot and an interfering face interfering with the robot are detected” when interference between any part (may include any part from the base of the robot to a tool part) constituting the robot (or a robot model covering the robot) and the outer surface of the motion zone or the limiting zone is detected.

The functional blocks of the robot controllers illustrated in FIG. 4, FIG. 13, and FIG. 19 may be provided by executing, by the processor in the robot controller, various types of software stored in a storage device or may be provided by a configuration mainly based on hardware such as an application specific integrated circuit (ASIC).

A program executing various types of processing, such as procedures for deciding on a stop category, in the embodiments described above can be recorded on various computer-readable recording media (such as semiconductor memories such as a ROM, an EEPROM, and a flash memory; a magnetic recording medium; and optical disks such as a CD-ROM and a DVD-ROM).

1. A robot controller for controlling a robot, the robot controller comprising:
a zone setting unit configured to set a motion zone where the robot is allowed to move or a limiting zone where the robot is not allowed to enter;
a position calculation unit configured to calculate a position of the robot;
an interference detection unit configured to detect interference between the robot and an outer surface of the motion zone or the limiting zone, based on the calculated position of the robot;
an operating state detection unit configured to detect an operating state of the robot when the interference is detected; and
a stop unit configured to stop the robot according to stop control based on the detected operating state.

2. The robot controller according to claim 1, further comprising
a stop method setting unit configured to set the stop control based on the operating state of the robot, wherein
the stop unit stops the robot according to the stop control being based on the operating state and being set by the stop method setting unit.

3. The robot controller according to claim 2, wherein
the operating state detection unit includes a moving direction detection unit configured to detect a moving direction of the robot when the interference is detected, and
the stop unit stops the robot according to the stop control based on the moving direction of the robot when the interference is detected.

4. The robot controller according to claim 3, wherein
the stop method setting unit is configured to be able to set different stop control for each moving direction of the robot.

5. The robot controller according to claim 3, wherein
the stop method setting unit is configured to be able to set a coordinate system being a reference when a moving direction of the robot is detected by the moving direction detection unit.

6. The robot controller according to claim 2, wherein
the operating state detection unit includes an interfering face detection unit configured to detect, out of a plurality of faces constituting an outer surface of the motion zone or an outer surface of the limiting zone, a face with which the robot interferes when the interference is detected, and
the stop unit stops the robot according to stop control based on the face interfering with the robot out of the plurality of faces when the interference is detected.

7. The robot controller according to claim 6, wherein
the stop method setting unit is configured to be able to set different stop control for each face constituting the outer surface of the motion zone or the outer surface of the limiting zone.

8. The robot controller according to claim 1, wherein
the zone setting unit is configured to be able to specify a signal for switching between enabling and disabling the motion zone or the limiting zone,
the interference detection unit is configured to detect the interference when, based on the signal, the motion zone or the limiting zone is enabled, and
the stop unit stops the robot according to the stop control based on the operating state of the robot when the interference is detected in a case where, based on the signal, the motion zone or the limiting zone is enabled.

9. The robot controller according to claim 8, wherein
the zone setting unit is configured to be able to specify a detection signal from a sensor for detecting entry of a person into the motion zone or the limiting zone as the signal for switching between enabling and disabling the motion zone or the limiting zone.

10. The robot controller according to claim 2, wherein
the stop method setting unit is configured to accept setting of the stop control based on the operating state of the robot through a user interface screen.

11. The robot controller according to claim 1, wherein
the zone setting unit is configured to accept setting related to the motion zone or the limiting zone through a user interface screen.
